(19) United States
(12) Patent Application Publication
(10) Pub. No.: US 2006/0224669 A1
(43) Pub. Date: Oct. 5, 2006

(54) Systems with application service overlay advised by knowledge overlay

(75) Inventors: Rita H. Wouhaybi, New York, NY (US); John Vicente, Roseville, CA (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/096,426

(22) Filed: Mar. 31, 2005

(51) Int. Cl. G06F 15/16

(52) U.S. Cl. 709/204

(57) ABSTRACT

A system having a knowledge overlay with a number of knowledge nodes, one or more application service overlays, each having a number of application service nodes and a number of client devices is disclosed. The application service nodes of a service overlay collaboratively provide an application service to the client devices, as well as report on data associated with the service provision to at least a subset of the knowledge nodes. The knowledge nodes collaboratively provide in response advice, based at least in part on the reported data, and the application service nodes selectively employ the advice to shape their provision of the service to the client devices.

### FIELD OF THE INVENTION

The present invention relates generally to the field of data processing and, in particular, to application service provisioning systems.

### BACKGROUND OF THE INVENTION

Advances in microprocessor and related technologies have led to wide spread deployment and adoption of numerous general purpose as well as special purpose computing devices. General purpose computing devices, such as nodes and desktop computers, are now endowed with computing power that was once reserved for the most expensive high end computers, requiring special conditioned environment to operate. At the same time, advances in networking, telecommunication, satellite, and other related technologies have also led to increase in connectivity between computing devices, making possible networked computing over private and/or public networks, such as the Internet.

However, as networked computing continues to grow in sophistication, enterprise networks become increasingly complex. From configuration, management, application service provision, to network protection, enterprises currently face many challenges.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a block diagram depicting data flow between the knowledge nodes and application service nodes of FIG. 1, in accordance with various embodiments;

FIG. 3 illustrates a flow chart view of a portion of the operational flow of a knowledge node of FIG. 1 in accordance with various embodiments;

FIG. 4 illustrates a flow chart view of a portion of the operational flow of an application service node of FIG. 1 in accordance with various embodiments;

FIG. 5 illustrates a flow chart view of a portion of the operational flow of a client device of FIG. 1, in accordance with various embodiments;

FIG. 6 illustrates an example computing device suitable for use as either one of the knowledge nodes, application service nodes or client devices of FIG. 1, for practicing the invention, in accordance with various embodiments; and

FIG. 7 illustrates a variation of the system of FIG. 1, in accordance with various embodiments; and

FIG. 8 illustrates another variation of the system of FIG. 1, in accordance with other embodiments.

### DETAILED DESCRIPTION OF ILLUSTRATIVE EMBODIMENTS

Illustrative embodiments of the present invention include but are not limited to knowledge overlays and nodes, application service overlay and nodes, client devices, networked devices and systems comprising such overlays, nodes and devices, and methods practiced thereon.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

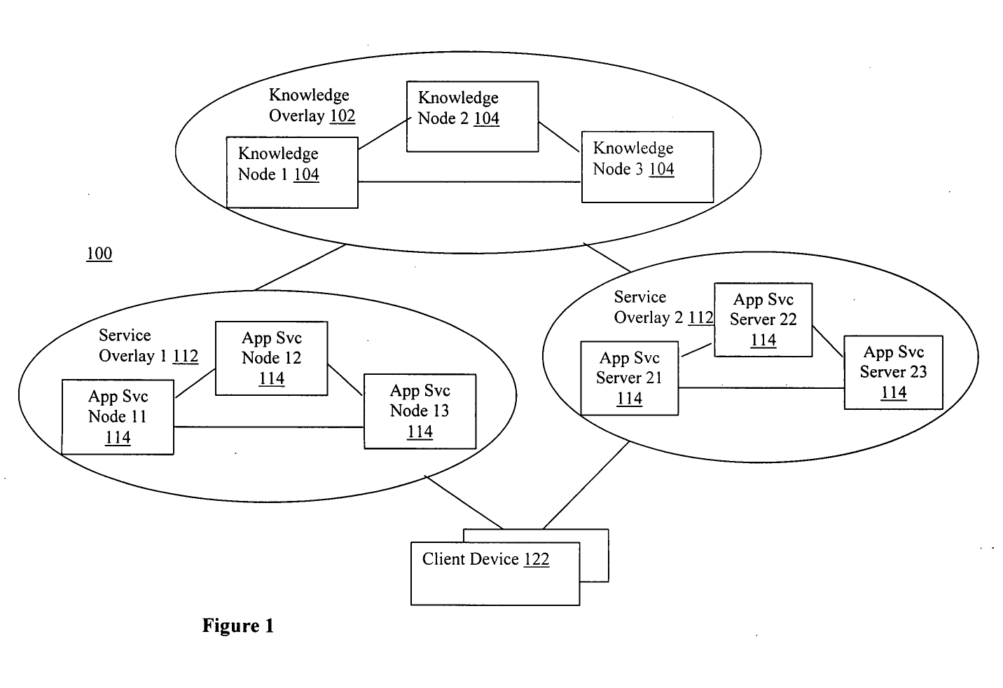

Referring now to FIG. 1, wherein a block diagram illustrating a system formed in accordance with various embodiments of the present invention is illustrated. As shown, system 100 comprises an knowledge overlay 102 having a number of knowledge nodes 104, a number of application service overlays 112, each having a number of application service nodes 114, and a number of client devices 122, selectively coupled to each other. In various embodiments, system 100 is an enterprise computing environment.

For the illustrated embodiments, application service nodes 114 of application service overlays 112 are employed to collaboratively provide a number of application services to client devices 122. As will be described in more detail below, application service nodes 114 are adapted to distributedly report to knowledge nodes 104, data associated with the provision and behavior of their application services to client devices 122. In response, knowledge nodes 104 collaboratively provide advice to application service nodes 114 based on the reported data, allowing application service nodes 114 to selectively employ the advice to shape the application services they collaboratively provide for client devices 122. Resultantly, application services may be provided to client devices 122 by application service nodes 114 more efficiently and effectively. In particular, application service nodes 114 may be more focused in the collaborative provision of application services, leaving the responsibilities of monitoring and understanding the state of system 100 to knowledge nodes 104.

A “node” as used herein (including in the claims) may be a physical or a logical “device”.

As shown, knowledge nodes 104 are selectively coupled to each other, and to application service nodes 114. The couplings may be physical or logical, and may be static or dynamic. Collectively, knowledge nodes 104 are said to form a knowledge overlay or plane 102 of system 100. While for ease of understanding, only three knowledge nodes 104 are illustrated, in alternate embodiments, the invention may be practiced with knowledge overlay 102 having more or less knowledge severs 104. Further, while the three knowledge nodes 104 are illustrated as coupled to each other, in alternate embodiments, the invention may be practiced with each of the knowledge nodes 104 merely selectively coupled to at least one other knowledge node 104, but not all knowledge nodes 104 of knowledge overlay 102.

Similarly, application service nodes 114 are selectively coupled to each other, and to knowledge nodes 104. The couplings may be physical or logical, and may be static or dynamic. Selective subsets of application service nodes 114 are said to form various service overlays or planes 112 of system 100. In various embodiments, each application service overlay 112 (or more specifically, its application service nodes 114) provides one type of application service. However, in alternate embodiments, an application service overlay 112 may offer more than one type of application services. While for ease of understanding, only three application service nodes 114 are illustrated for each of the application service overlay 112, in alternate embodiments, the invention may be practiced with one or more of application service overlays 112 having more or less application service nodes 114. Further, while the three application service nodes 114 of each application service overlay 112 are illustrated as coupled to each other, in alternate embodiments, the invention may be practiced with each of the application service nodes 114 of an application service overlay 112 merely selectively coupled to at least one other application service nodes 114, but not all application service nodes 114 of the application service overlay 112 (hereinafter may also be simply referred to as service overlay).

Client devices 122 are selectively coupled to application service nodes 114. The couplings may be physical or logical, and may be static or dynamic.

As described earlier, application service nodes 114 of the various service overlays 112 collaboratively provide application services to client devices 122. That is, an application service may be provided to a client device 122 by one or more application service nodes 114 of a service overlay 112, in the latter case, cooperatively among the application service nodes 114. The term “application service” as used herein (including the claims) are intended to broadly include services that may be referred to as system or utility services, such as virus protection, firewall, proxy, best route selections, query processing, and so forth. In other words, the term ‘application service” is to be broadly construed to include all known or to be devised “services” provided in a system, for consumption by or the benefit of a client device.

Further, application service nodes 114 distributedly report raw data associated with provision of application services to client devices 122 to knowledge nodes 104. The term “distributedly” as used herein refers to the fact that application service nodes 114 selectively report the data to the different knowledge nodes 104. However, by virtue of the cooperation among knowledge nodes 104, notwithstanding to the disbursed manner of reporting, the data may be effectively possessed by all knowledge nodes 104.

The term “data” when used in the context of data associated with the provision of the application services to client devices 122 is also intended to be broadly construed to include a wide range of observable, measurable, detectable or otherwise representable quantities. Likewise, the term “advice” is intended to be broadly construed to include a wide range of instructions, warnings, suggestions, recommendations, guidance, admonitions, and so forth.

In various embodiments, knowledge nodes 104 may also be provided with additional data and/or knowledge, e.g. from an administrator, and employ these additional data and/or knowledge in their collaborative provision of advice to application service nodes 114.

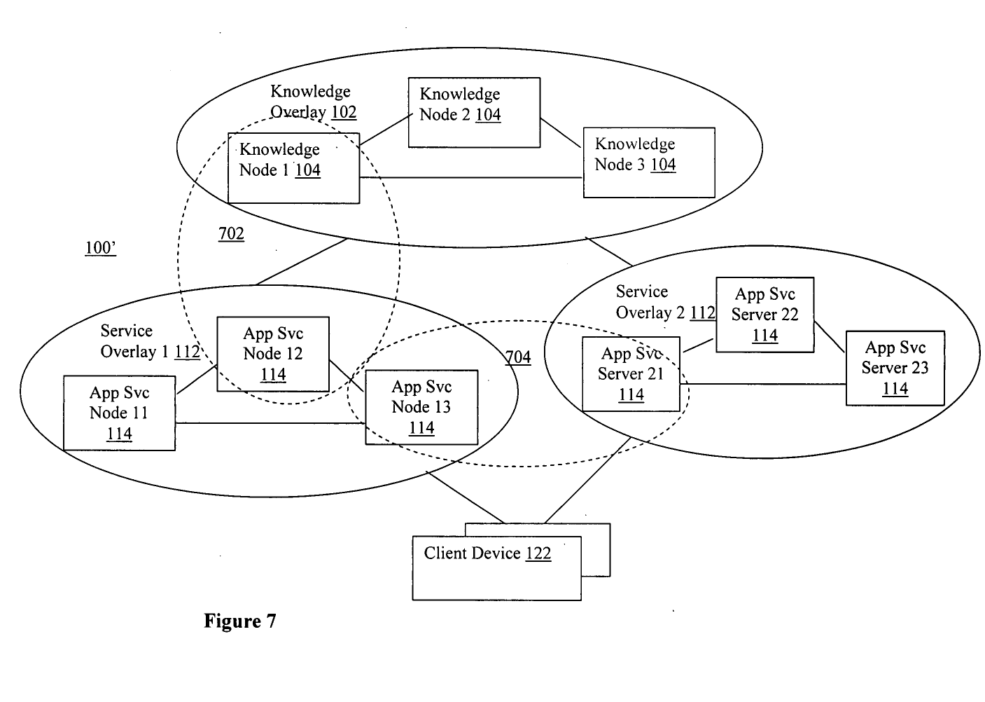

Still further, while for ease of understanding, separate illustrations are provided for knowledge nodes 104, application service nodes 114, and client devices 122, a node/device may be one or more of these at the same time, or at different points in time. Such a node/device would be adapted with the corresponding logic (capability) to operate in the corresponding role(s). For example, as illustrated in FIG. 7, knowledge node 1 and application service node 12 may be disposed on the same physical device 702 (e.g. a server as represented by the oval shape with the dotted boundary). Likewise, application service node 13 and application service 21 may also be disposed on the same physical device 704 (e.g. a server represented by the corresponding oval shape having also a dotted boundary). Thus, the present invention anticipates various modification, extensions, combinations, and so forth, that are within the ability of those of ordinary skill in the art.

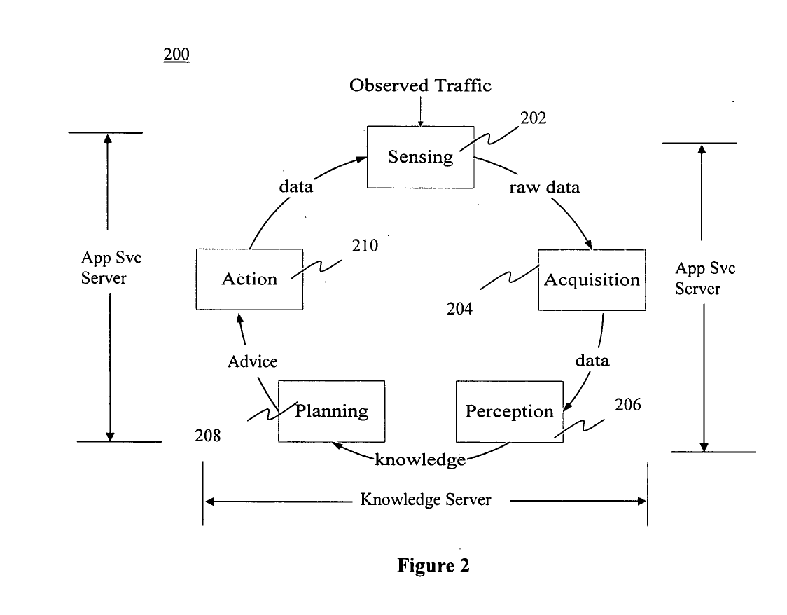

FIG. 2 illustrates a block diagram depicting data flow between knowledge nodes 104 and application service nodes 114, in accordance with various embodiments. As illustrated, for the embodiments, application service nodes 114 sense 202 or otherwise monitor network traffic associated with their corresponding application service provisioning, and gathers raw data from the observed network traffic (e.g. packets) through the connections of the various client devices 122. Application service nodes 114 process the raw data, or otherwise acquire 204 the raw data into processed/refined data (e.g. statistical measures). As described earlier, application service nodes 114 distributedly report the acquired processed/refined data to knowledge nodes 104.

Knowledge nodes 104 in turn collaborate to perceive 206 or otherwise synthesize the received data into knowledge (e.g. inferring occurrence of an event, or presence of a condition). The term “knowledge” as used herein is intended to be broadly construed to include a wide range of information. Thereafter, knowledge nodes 104 plan 208 or otherwise devise advice for application service nodes 114, based at least in part on the synthesized knowledge. On devising the advice, knowledge nodes 104 communicate the advice (e.g. a suggested action) to the appropriate ones of application service nodes 114.

On receipt, application service nodes 114 selectively employ or act 208 on the received advice. The action in turn may result in a modification of data for the sensing or monitoring operations, e.g. adapting the sensing and/or monitoring.

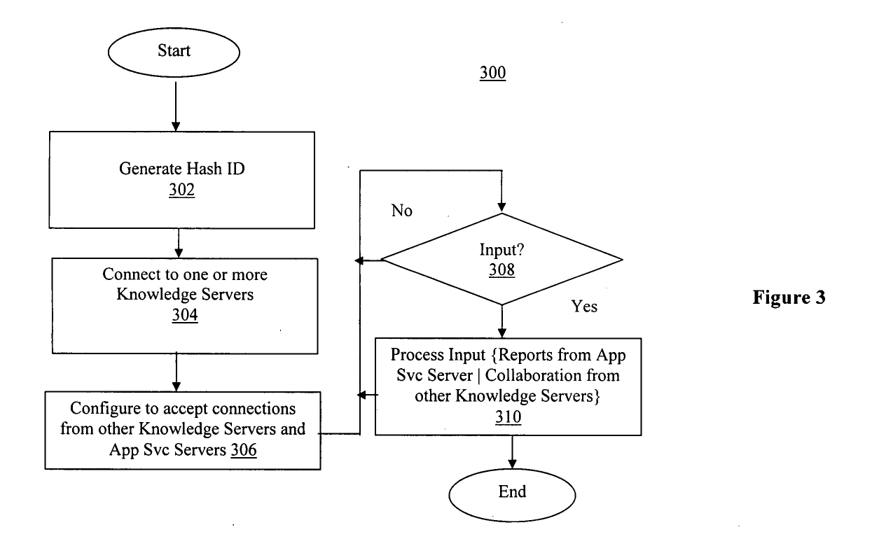

FIG. 3 illustrates a portion of the operation flow of a knowledge node of FIG. 1, in accordance with various embodiments. As illustrated, for the embodiments, on start up, a knowledge node 104 generates 302 a hash identifier for itself, for use to position itself in the knowledge overlay 102 by connecting to one or more other existing knowledge nodes 104 of knowledge overlay 102. Subsequently, the knowledge node 104 uses the hash identifier, and connects 304 itself to one or more other knowledge nodes 104 of knowledge overlay 102. Next, the knowledge node 104 configures 306 its own internal system/applications including its firewall, if needed, to allow connections from other knowledge nodes 104, and application service nodes 114 that might connect to it at later stages.

Thereafter, the knowledge node 104 waits 306 for an input to process. The input may e.g. be a reporting on a data associated with the provision of service (from an application service node 114), or a request to collaborate (by one or more other knowledge nodes. 104) to synthesize knowledge or to offer advice. In response, the knowledge node 104 processes 308 and responds to the input accordingly. For example, the processing of reported data may include summarizing and/or storing the summarized or aggregated data into a database or repository, or otherwise performing one or more machine learning processes. Whereas, the process of a request to collaborate may include e.g. cooperating with other knowledge nodes 104 to model or otherwise simulate the data to infer or generate an advice.

Upon processing the input, knowledge node 104 continues its operation at block 306, until eventually, it decides to leave the knowledge overlay 102. At such time, knowledge node 104 stops operation, and disconnects.

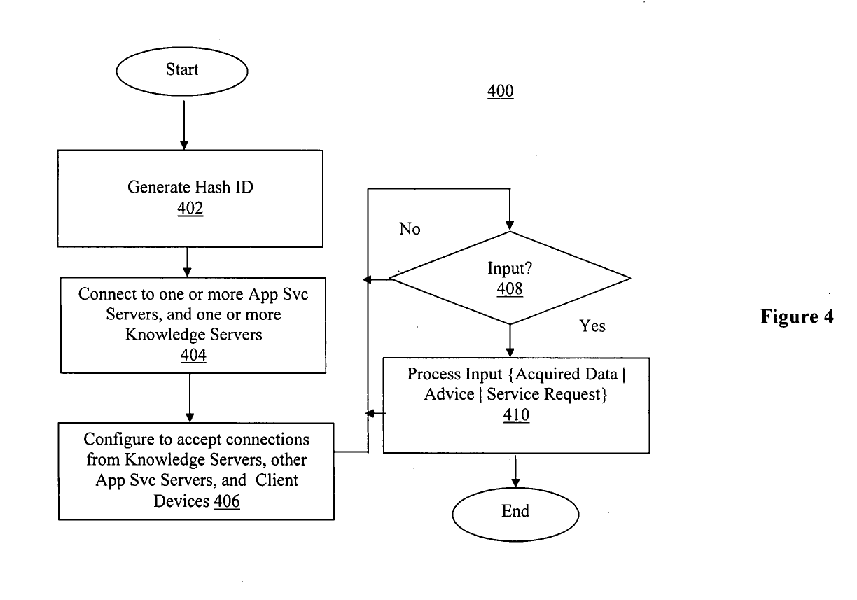

FIG. 4 illustrate a portion of the operation flow of an application service node of FIG. 1, in accordance with various embodiments. As illustrated, for the embodiments, on start up, an application service node 114 generates 402 a hash identifier for itself, for use to position itself in the service overlay 112 by connecting itself to one or more other application service nodes 114 of service overlay 112. Subsequently, the application service node 114 uses the hash identifier, and connects 404 itself to one or more other application service nodes 114 of service overlay 112. Next, the application service node 114 uses 402 in order to figure out to which knowledge node it should connect. Then, the application node 114 configures 406 its own internal system/applications including its firewall, if needed, to allow connections from the knowledge node 104 it connected to, and other application service nodes 114 and client devices 122.

Thereafter, the other application service node 114 waits 408 for an input to process. The input may e.g. be acquisition of data associated with the provision of service, receipt of an advice from a knowledge node 104, or a request to provide service to a client device 122. A request to provide service to a client device 122 may be from the device itself or from another application service node 114. In response, the other application service node 114 processes 410 and responds to the input accordingly. For example, the processing of acquired data may include reporting the acquired data to a knowledge node 104, as described earlier, and the processing of a received advice may include acting on the advice. Whereas, the processing of a received request to provide service to a client device 122 may include providing the requested service to the client device 122 alone, or in conjunction with other application service nodes 114.

Upon processing the input, other application service node 114 continues its operation at block 406, until eventually, it decides to leave the service overlay 112. At such time, other application service node 114 stops operation, and disconnects.

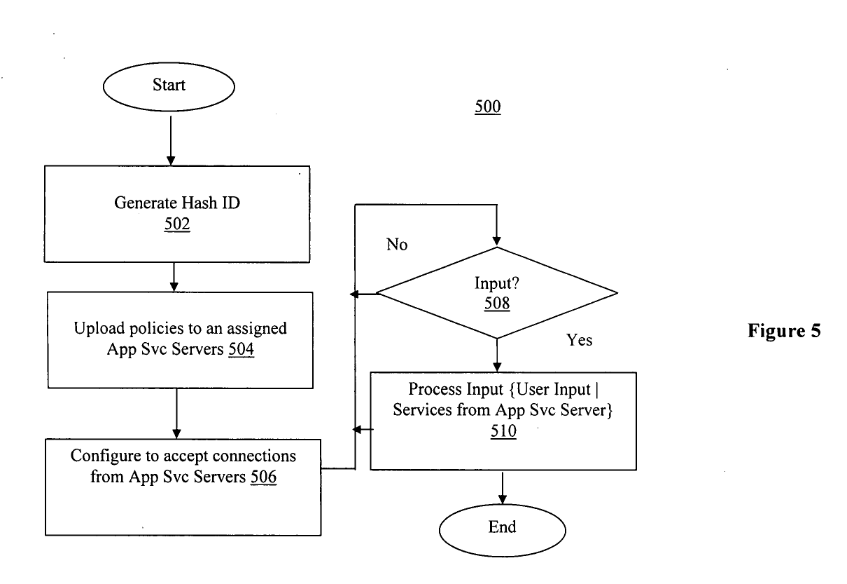

FIG. 5 illustrate a portion of the operation flow of a client device of FIG. 1, in accordance with various embodiments. As illustrated, for the embodiments, on start up, a client device 122 generates 502 a hash identifier for itself, for use to connect itself to one or more application service nodes 114 of service overlay 112. Subsequently, for the embodiments, the client device 122 uses the hash identifier, connects 404 itself to a designated application service node 114 of service overlay 112, and uploads policies, if any, governing provision of application services to the client device 122. Next, the client device 122 configures 506 its own internal system/applications including its firewall, if needed, to allow connections from application service nodes 114.

Thereafter, the client device 122 waits 508 for an input to process. The input may e.g. a user input or service from application service nodes 114. In response, the client device 122 processes 410 and responds to the input accordingly. For example, the processing of user input data may include requesting service from an application service node 114, as described earlier, and the receipt of service from application service nodes 114 may include “consuming” the service provided.

Upon processing the input, other client device 122, continues its operation at block 506, until eventually, the input is an instruction to terminate operation. At such time, client device 122 stops operation, and “shuts down”.

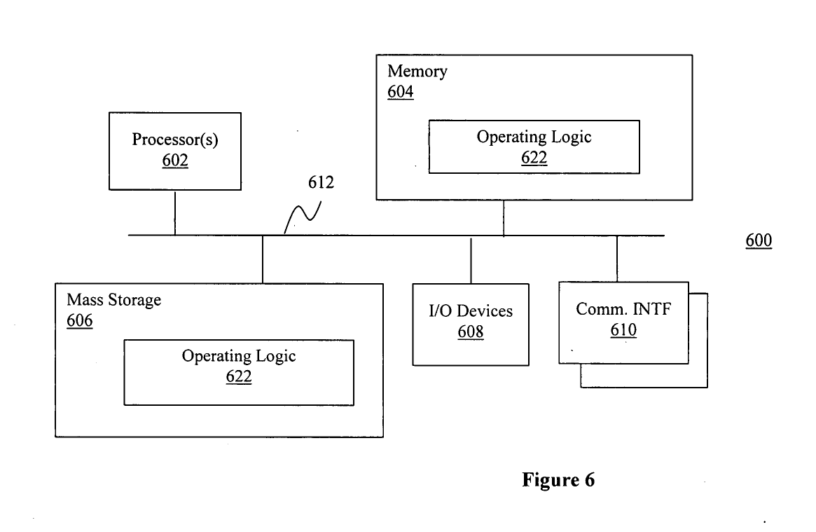

FIG. 6 illustrates a block diagram view of an example computing device suitable for use as one or more of the illustrated devices of FIG. 1, in accordance with one embodiment. As illustrated, computing device 600 includes processor 602, memory 604 coupled to each other via bus 612. Further, computing device 600 also includes mass storage device 606. I/O devices 608, and communication interface 610 coupled to the earlier described elements as shown.

Each of the elements represents a broad range of the corresponding element known in the art or to be designed consistent with the teachings of the present invention. They perform their conventional functions, i.e. processing, storage, and so forth. In particular, memory 604 and mass storage 606 are employed to store temporal and persistent copies of operating logic 622. Depending on whether computing device 600 is adapted for use as knowledge node 104, application service node 114, and/or client devices 122, operating logic 622 may be adapted to practice the operational flow of FIG. 3, 4 and/or 5, accordingly.

In various embodiments, communication interface 610 includes a networking interface. In various embodiments, for embodiments adapted for use as a client device 122, computing device 600 may be a desktop computer, a tablet computer or a palm sized computing device.

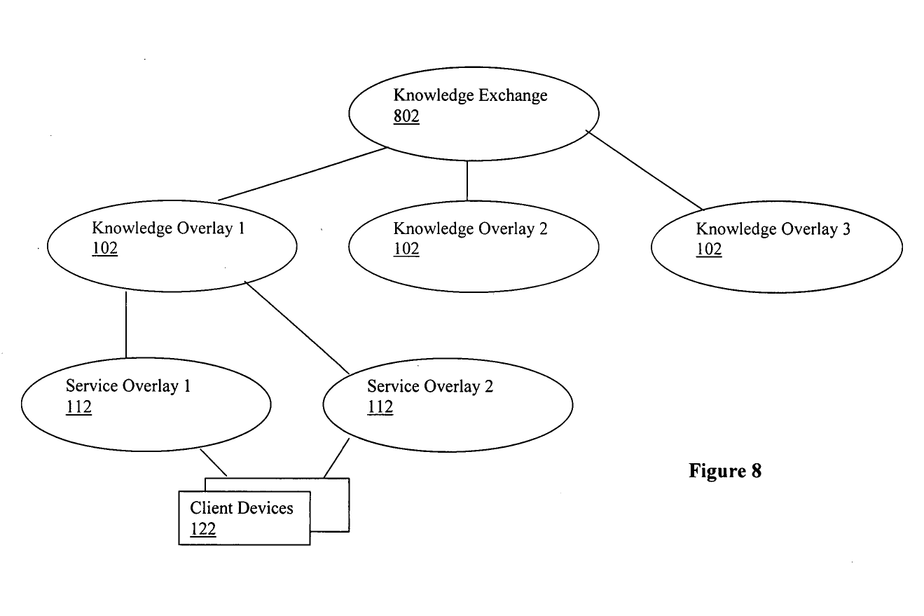

FIG. 8 illustrates another variation of system 100, in accordance with various embodiments. In these embodiments, system 100 has multiple knowledge overlays 102, coupled to each other via knowledge exchange 802. Knowledge exchange 802 may include one or more knowledge nodes. For these embodiments, knowledge nodes of knowledge exchange 802 may be similarly constituted as earlier described for knowledge nodes 104 of knowledge overlay 102. As to knowledge nodes 104 of knowledge overlays 102, they additionally connect to at least one knowledge node of knowledge exchange 802, and allow connections from knowledge nodes of knowledge exchange 802.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. An apparatus, comprising:
a network interface to couple the apparatus to a network; and
a knowledge node, operatively coupled to the network interface, and adapted to collaborate with one or more other knowledge nodes of a knowledge overlay, to distributedly receive reports from a plurality of application nodes of a service overlay, and in response, cooperatively provide the plurality of application nodes with a plurality of advice, the application nodes of the service overlay providing application services to a plurality of client devices, the reports reporting on data associated with the providing of application services to the client devices, and the advice being employable by the application nodes to shape their provision of application services to the client devices.

2. The apparatus of claim 1, wherein the knowledge node is further adapted to generate a hashed identifier for itself, for use as an identifier to connect the knowledge node to one or more of the other knowledge nodes.

3. The apparatus of claim 1, wherein the knowledge node is further adapted to connect to one or more of the other knowledge nodes of the knowledge overlay, and to one or more of the application nodes of the service overlay.

4. The apparatus of claim 1, wherein the knowledge node is further adapted to accept a connection from a knowledge exchange, one of the other knowledge nodes of the knowledge overlay, or one of the application nodes of the service overlay.

5. The apparatus of claim 1, wherein the knowledge node is further adapted to cooperate with the one or more other knowledge nodes to synthesize knowledge based on the reported data associated with the application services being provided by the application nodes of the service overlay.

6. The knowledge node of claim 5, wherein the knowledge node is further adapted to cooperate with the one or more other knowledge nodes to generate the advice based at least in part on the knowledge synthesized.

7. An apparatus, comprising:
a networked interface to couple the apparatus to a network;
a storage medium having stored therein instructions adapted to implement an application node on the apparatus, that collaborates with one or more other application severs of a service overlay, to provide an application service to a plurality of client devices, to report to one or more knowledge nodes of a knowledge overlay on the collaborative provision of the application service to the client devices, to receive from one or more knowledge nodes advice generated based at least in part on the reports, and to selectively employ the received advice in shaping the provision of the application service to the client devices; the reports reporting on data associated with the providing of the application service to the client devices; and
a processor coupled to the storage medium and the network interface to execute the instructions.

8. The apparatus of claim 7, wherein the instructions are further adapted to generate a hashed identifier for itself, as an identifier, to connect to one or more of the application nodes of the service overlay, and one or more of the knowledge nodes of the knowledge overlay.

9. The apparatus of claim 7, wherein the instructions are further adapted to enable the application node to connect to one or more of the other application nodes of the application service overlay, and to one or more of the knowledge nodes of the knowledge overlay.

10. The apparatus of claim 7, wherein the instructions are further adapted to enable the application node to accept a connection from one of the knowledge nodes of the knowledge overlay, one of the other application nodes of the service overlay, or one of the client devices.

11. A system comprising
a first client device;
a first plurality of application service nodes selectively coupled to each other and to the first client device, defining a first service overlay, to collaboratively provide a first application service to the first client device; and
a first plurality of knowledge nodes selectively coupled to each other and to the first application service nodes, defining a first knowledge overlay, to distributedly receive reports on data associated with the collaborative provision of the first application service to the first client device, and in response, collaboratively provide advice to the first application service nodes, for selective employment by the first application service nodes in shaping the provision of the first application service to the first client device.

12. The system of claim 11, further comprising a server having
a networked interface to couple the server to a network;
a storage medium having stored therein instructions adapted to implement one of the application service nodes to collaborate with the other application service nodes to provide the first application services to the client device; and
a processor coupled to the storage medium and the network interface to execute the instructions.

13. The system of claim 12, wherein the instructions are further adapted to report to one or more of the knowledge nodes on the collaborative provision of the first application service to the first client device.

14. The system of claim 13, wherein the instructions are further adapted to receive from one or more of the knowledge nodes advice generated based at least in part on the reports, and to selectively employ the received advice in shaping the provision of the first application service to the first client device.

15. The system of claim 11, further comprising a server having
a networked interface to couple the server to a network;
a storage medium having stored therein instructions adapted to implement a knowledge node to collaborate with one or more other knowledge severs to distributedly receive reports from the first application nodes; and
a processor coupled to the storage medium and the network interface to execute the instructions.

16. The system of claim 15, wherein the instructions are further adapted to cooperate with the other knowledge nodes to provide, in response, to the application nodes, the advice.

17. The system of claim 16, wherein the instructions are further adapted to cooperate with at least a subset of the other knowledge nodes, to synthesize knowledge, based on the reported data associated with the first application service being provided by the first application nodes, and to generate the advice based at least in part on the knowledge synthesized.

18. The system of claim 11, wherein the system further comprises a second plurality of application service nodes selectively coupled to each other and to the first client device or a second client device, defining a second service overlay, to collaboratively provide a second application service to the first client device or the second client device.

19. The system of claim 11, wherein the system further comprises a second plurality of knowledge nodes selectively coupled to each other and to either selected ones of the first knowledge nodes or selected ones of the first application service nodes, defining a second knowledge overlay, to assist in providing said advice to the first application service nodes.

20. The system of claim 19, wherein the system further comprises a knowledge exchange coupled to selected ones of the first and second plurality of knowledge nodes to facilitate said assisting by the second knowledge nodes.
